(19) United States
(12) Patent Application Publication
(10) Pub. No.: US 2026/0326302 A1
(43) Pub. Date: Oct. 22, 2026

(54) METHOD AND APPARATUS FOR CALIBRATING A ROBOT, METHOD FOR DETERMINING THE 3D COORDINATES OF A MEASUREMENT OBJECT, METHOD FOR DETERMINING THE POSITION AND ORIENTATION OF A MEASUREMENT OBJECT, ROBOT, AND COMPUTER PROGRAM

(71) Applicant: Carl Zeiss GOM Metrology GmbH, Braunschweig (DE)

(72) Inventors: Manuel Winter, Frankfurt (DE); Bennet Boettinger, Braunschweig (DE)

(21) Appl. No.: 19/714,377

(22) Filed: Jun. 19, 2026

Related U.S. Application Data
(63) Continuation of application No. PCT/EP2024/086998, filed on Dec. 18, 2024.

(30) Foreign Application Priority Data
Dec. 22, 2023 (DE) 10 2023 136 448.0

(51) Int. Cl. B25J 9/16

(52) U.S. Cl. CPC B25J 9/1692; B25J 9/1653; B25J 9/1669; B25J 9/1697

(57) ABSTRACT

A method for calibrating a robot kinematic system bringing a 3D digitizer and/or a camera into different relative poses with respect to one another in relation to a reference object and recording data of recognizable features of the reference object by the 3D digitizer and/or the camera, generating calibration data at least from a portion of the recorded data, and deriving calibration parameters for the at least one robot kinematic system from the generated and recorded calibration data. Further, a robot kinematic system and an apparatus for calibrating a robot kinematic system with a coordinate measuring machine or as part of a coordinate measuring machine, a method for determining the 3D coordinates of a measurement object, a method for determining the position and orientation of a measurement object, and a computer program containing instructions that, when executed by a processor, cause the processor to carry out the methods, are provided.

### CROSS REFERENCE TO RELATED APPLICATIONS

This application is a continuation application of international patent application PCT/EP2024/086998, filed Dec. 18, 2024, designating the United States and claiming priority to German application 10 2023 136 448.0, filed Dec. 22, 2023, and the entire content of both applications is incorporated herein by reference.

### TECHNICAL FIELD

The present disclosure relates to a robot, to a method and to an apparatus for calibrating a robot with a coordinate measuring machine or as part of a coordinate measuring machine, to a method for determining the 3D coordinates of a measurement object, and to a method for determining the position and orientation of a measurement object.

The present disclosure furthermore relates to a non-transitory computer-readable storage medium on which a computer program containing instructions that, when the program is executed by at least one processor, cause the at least one processor and/or further processors to carry out the methods according to the disclosure.

### BACKGROUND

Robot kinematic systems (also referred to hereinafter as robots) are mechanical structures in which one or more axes are coupled to one another. Robot kinematic systems aim to bring an end effector into a specific position and orientation (pose) in relation to a reference system. An axis is understood here to mean the movable connection of two structural components of the robot kinematic system, wherein this connection may be movable in up to six degrees of freedom. Examples of this are a typical robot axis of rotation, which permits only a rotation in one rotational degree of freedom, a typical linear axis, which permits a translational movement in one translational degree of freedom, or a spherical joint (ball joint), which permits rotations in three rotational degrees of freedom. Typical robot kinematic systems are six-axis robots. In particular, however, a rotary table may also be considered to be a robot kinematic system. The robot axes here may either be provided with an actuator, or may be operated only passively. The reference system may for example be defined by the ground. Within the scope of the present disclosure, therefore, mobile robot kinematic systems traveling on corresponding mobile platforms may for example also be calibrated individually or with respect to one another. In this case, the reference system may be defined by the base of the platform, which does not move during the measurement.

Robot kinematic systems, whether parallel, serial or else parallel-and-serial coupled, such as for example an articulated arm on a delta robot, are inaccurate in many respects for measurement purposes. This means that the nominal forward kinematics do not correspond to the real forward kinematics. This is caused for example by geometric inaccuracies, elastic deformations, thermal expansions and inaccuracies in the determination of the axis values. This is especially problematic when the pose of the end effector or of the tool mounted on the end effector (measuring machine, work tool, etc.) must be determined with very high accuracy or is used for measurement purposes. The end effector is the end interface along the link chain of the robot kinematic system or the tool attached to the end interface.

In optical metrology, in particular 3D coordinate metrology, a measurement object can usually only be captured partially by an optical measurement system due to the latter's limited measurement range. The measurement system is therefore brought into different poses in relation to the measurement object with a robot in order to capture the measurement object as completely as possible. The data present locally in the reference coordinate system of the measurement system are then combined in a global coordinate system. It is necessary here to know the position and orientation of the measurement system in relation to the measurement object as accurately as possible. This accuracy is related directly to the positioning accuracy of the robot or to the accuracy with regard to the determination of the position of the end effector. Higher robot calibration accuracy enables more accurate determination of the position of the measurement system and, consequently, more accurate measurement of the measurement object as a whole.

Measurement objects may be so large that even the range of a robot is not sufficient to capture the measurement object with the measurement system attached to the robot. In this case, the measurement object must be displaced and realigned with respect to the robot in order, in this case too, to be able to transfer the data into a common global coordinate system before and after the displacement of the measurement object. This is usually carried out on the basis of recognizable features that are attached to or around the measurement object and are captured by the measurement system before and after the displacement. The better the robot is calibrated, the more accurate the alignment.

In 3D coordinate metrology, 3D digitizers are used to measure 3D data. The 3D data may be generated using different methods, such as for example by triangulation with at least two cameras or one camera and a projector, time-of-flight (TOF) measurement, lidar, confocal measurement, etc. In this case, the 3D data may be present for example in the form of individual 3D points of discrete features or as a full-field mesh consisting of a multitude of surface points. 3D data may also be generated with a 2D camera. However, a single 2D camera, which cannot generate 3D data in a single pose without further prior knowledge of the measurement object, such as for example a distance between features of the measurement object, is not a 3D digitizer in the context of the disclosure. 2D cameras are also referred to simply as cameras below.

EP 2 489 977 B1 describes a method involving a measurement system for determining the 3D coordinates of an object, comprising a camera and a projector and a reference camera for recording reference marks of an array of reference marks in order to determine the position and orientation of the measurement system from one or more recordings from the reference camera and an industrial robot for positioning the measuring system, wherein the measuring system and the array of reference marks are used to calibrate the robot.

Since the determination of the pose is inaccurate due to the acquisition of the data as 2D data with a reference camera and thus a 2D camera, particularly in the viewing direction of the 2D camera, EP 2 489 977 B1 furthermore proposes using multiple reference cameras aligned in different viewing directions. However, the use of further 2D cameras increases the costs of the system along with the weight that has to be attached to the end effector of a robot. This may mean that it is necessary to use a robot that provides a correspondingly high load capacity.

EP 3 377 948 B1 describes a method in which, at a plurality of times of a sampling schedule, the poses of a camera system of a robot relative to a reference coordinate frame are obtained on the basis of a comparison of three-dimensional images of a scene and the positions of the robot are obtained on the basis of a second sampling schedule, in order to determine the position of the reference coordinate frame and the reference point of the camera system relative to the position of the robot. In this case, a plurality of equations are created and used to solve an optimization problem, with it being described that the position of the reference coordinate frame, the tool center point of the camera system, a possible time offset and parameters of the robot model can be optimized in the optimization method. One input parameter of the optimization method is the position of the camera system, which is given by a comparison of the three-dimensional images of the scene.

As mentioned in EP 3 377 948 B1, it is difficult, in particular in regions with few features, to align the three-dimensional images appropriately with visual odometry.

This is applicable in particular for low-resolution 3D digitizers with a small measurement volume. The larger the measurement volume, the higher the probability of capturing a feature, and the higher the resolution, the higher the probability of recognizing a feature or accurately capturing its position.

“Dynamic Photogrammetric Calibration of Industrial Robots” Videometrics V, SPIE Proceedings Series Vol. 3174, SPIE's 42nd Annual Meeting, San Diego, 27.7.-1.8. 1997 describes a method for calibrating a robot, in which a reference object is attached to a robot and 3D coordinates of marked targets of the reference object are determined by being recorded with three mutually synchronized cameras. The poses of the end effector are determined on the basis of the 3D coordinates of the marked targets. The 3D coordinates and the orientation and the camera model parameters of the three-camera system are determined simultaneously in this case.

The drawback of the method is that inexpensive cameras have a very low resolution, and it is thus not possible to determine, very accurately, the position of the targets of the reference object in the camera images, and thus also in space.

### SUMMARY

It is an object of the present disclosure to provide a method and an apparatus for calibrating a robot kinematic system and also a method for determining the 3D coordinates of a measurement object and a method for determining the position and orientation of a measurement object and also a robot kinematic system and a non-transitory computer-readable storage medium on which a computer program for carrying out the method according to the disclosure is stored, thereby solving the abovementioned problems.

Against this background, what is proposed according to an aspect of the disclosure is a method for calibrating robot kinematic systems, the method including at least:
a first step,
   a) in which at least one 3D digitizer which is fastened to a first robot kinematic system and at least one camera which is fastened to the first robot kinematic system or to a further second robot kinematic system, and at least one reference object which has recognizable features and which is located in the surroundings of one robot kinematic system or in the surroundings of both robot kinematic systems, and which is stationary, are brought into different relative poses with respect to one another by the robot kinematic system or the robot kinematic systems, and in which data of the recognizable features of the reference object are recorded by the at least one 3D digitizer and by the at least one camera in these different relative poses; or
   b) in which at least one 3D digitizer which is located and fixed in the surroundings of a first robot kinematic system and at least one camera which is fixed in the surroundings and at least one reference object having recognizable features which is fastened to the first robot kinematic system are brought into different relative poses with respect to one another by the first robot kinematic system, and in which data of the recognizable features of the at least one reference object are recorded by the at least one 3D digitizer and the at least one camera in these different relative poses; or
   c) in which at least one reference object having recognizable features which is fastened to a first robot kinematic system and has recognizable features, and at least one 3D digitizer which is fastened to a second robot kinematic system or to a third robot kinematic system, and/or at least one camera which is fastened to a second robot kinematic system or to a third robot kinematic system, are brought into different relative poses with respect to one another by the first robot kinematic system and the second robot kinematic system and/or the third robot kinematic system, and in which data of the recognizable features of the at least one reference object are recorded by the at least one 3D digitizer and/or the at least one camera in these different relative poses;
   wherein,
      in at least one further second step, calibration data, which correlate the recorded recognizable features of the at least one reference object in a coordinate system, are generated at least from a portion of the recorded data; and, in at least one other third step, calibration parameters for the robot kinematic system or the robot kinematic systems are derived from the calibration data generated in the second step and at least from a portion of the data recorded in the first step; and
   wherein,
      in the case of substep a) or substep b), for the generation of the calibration data, at least a portion of the recorded data are data that were generated by the at least one camera and, for the derivation of the calibration parameters, at least a portion of the recorded data are data that were generated by the at least one 3D digitizer; and in the case of substep c), for the generation of the calibration data and for the derivation of the calibration parameters, use is made of any desired selection of the recorded data that were generated by the at least one camera and/or the at least one 3D digitizer.

It goes without saying that the camera for all of the first substeps of the method for calibrating a robot kinematic system may also be part of the 3D digitizer. Of course, this also applies to the following method for calibrating a measurement object and aligning a measurement object, and to the corresponding apparatus.

According to a further aspect of the present disclosure, what is proposed is a method for determining the 3D data of a measurement object, wherein at least one 3D digitizer fastened to a robot kinematic system or multiple 3D digitizers fastened to robot kinematic systems are brought into different poses for measuring the measurement object, and the one or more 3D digitizers generate local 3D data in the reference coordinate systems of the 3D digitizers, and wherein the local 3D data generated at the different poses are transferred into a global coordinate system on the basis of the calibration parameters of the robot kinematic systems as derived in accordance with the method according to the disclosure.

According to a further aspect of the present disclosure, what is proposed is a method for aligning a measurement object in relation to a robot kinematic system on the basis of recognizable features that are distributed on or around the measurement object and are captured by at least one 3D digitizer fastened to a robot kinematic system and/or by at least one camera fastened to a robot kinematic system, wherein the calibration parameters of the robot kinematic system have been derived with the method according to an aspect of the disclosure.

According to a further aspect of the present disclosure, what is proposed is an apparatus for calibrating robot kinematic systems, said apparatus comprising at least the following components:
at least one 3D digitizer fastened to a first robot kinematic system and at least one camera fastened to the first robot kinematic system or to a further second robot kinematic system, and at least one reference object having recognizable features which is located in the surroundings of one robot kinematic system or in the surroundings of both robot kinematic systems, which is stationary for the recordings, or
at least one 3D digitizer located and fixed in the surroundings of a first robot kinematic system and at least one camera fixed in the surroundings and at least one reference object having recognizable features which is fastened to the first robot kinematic system, or at least one reference object having recognizable features which is fastened to a first robot kinematic system, and at least one 3D digitizer, wherein the 3D digitizer is fastened to a second robot kinematic system or to a third robot kinematic system, and/or at least one camera, wherein the camera is fastened to a second robot kinematic system or to a third robot kinematic system,
wherein, for at least one of the robot kinematic systems, calibration parameters for the robot kinematic system are derived with the method according to an aspect of the disclosure.

According to a further aspect of the present disclosure, what is proposed is a robot kinematic system the calibration parameters of which have been derived with the method according to an aspect of the disclosure.

What is furthermore proposed is a computer program containing instructions that, when the program is executed by at least one processor, cause the at least one processor and/or further processors to carry out the method according to an aspect of the disclosure.

According to another aspect of the disclosure, provision is made for a method for calibrating robot kinematic systems, wherein data for calibrating a reference object and for deriving the calibration parameters of the robot kinematic system or robot kinematic systems are generated.

The data are recorded by virtue of at least one 3D digitizer fastened to a first robot kinematic system and at least one camera, wherein the camera is fastened to the first robot kinematic system or to a further second robot kinematic system. At least one reference object having recognizable features, is located in the surroundings of one robot kinematic system or of both robot kinematic systems, is stationary for the recordings, is brought into different relative poses with respect to one another by the robot kinematic system or the robot kinematic systems. Data of the recognizable features of the reference object are recorded by the at least one 3D digitizer and by the at least one camera in the different relative poses.

As an alternative, the data are recorded by virtue of a reference object fastened to a robot kinematic system being brought into different relative poses with respect to a 3D digitizer located and fixed in the surroundings of the robot kinematic system and to a camera located and fixed in the surroundings of the robot kinematic system by the robot kinematic system, and data of the recognizable features of the reference object being recorded in these different relative poses.

As a further alternative, however, data may also be recorded by virtue of a reference object having recognizable features which is fastened to a first robot kinematic system, and at least one 3D digitizer, wherein the 3D digitizer is fastened to a second robot kinematic system or to a third robot kinematic system, and/or at least one camera, wherein the camera is fastened to a second robot kinematic system or to a third robot kinematic system, being brought into different relative poses with respect to one another and data of the recognizable features of the reference object being recorded in these different relative poses. It is thus possible, with a 3D digitizer and a camera, for example, for the 3D digitizer and the camera to be fastened to a second robot kinematic system or for the 3D digitizer to be fastened to a second robot kinematic system and for the camera to be fastened to a third robot kinematic system or for the camera to be fastened to a second robot kinematic system and for the 3D digitizer to be fastened to a third robot kinematic system. It is just possible, for example, for only a 3D digitizer or only a camera to be fastened to the second robot kinematic system.

In principle, it is possible to derive calibration parameters for a plurality of robot kinematic systems, these calibration parameters recording data in accordance with one of the variants mentioned depending on the subsequent task of the robot kinematic system. The variant with regard to recording the data for the respective robot kinematic system may in this case be different from a variant for recording the data with one of the other robot kinematic systems.

On the one hand, the recorded data may be 2D data that are recorded with one or more cameras, these possibly also being one or more cameras of the 3D digitizer. On the other hand, it may be 3D data generated by the 3D digitizer.

The utilization of a camera, especially if it is a high-resolution camera, is advantageous for calibrating the recognizable features of the reference object. The utilization of a 3D digitizer is advantageous for determining the pose of the end effector, since depth data are also relevant in particular for determining the pose. It is thus possible to utilize a high-quality high-resolution camera to calibrate the recognizable features of the reference object on the basis of 2D data, and a 3D digitizer to determine with high accuracy the pose of the end effector on the basis of 3D data. Nevertheless, it is also possible to utilize a camera to determine the pose of the end effector or a 3D digitizer to calibrate the recognizable features of the reference object or to combine both with one another.

Calibration data, which correlate the recorded features of the reference object in a coordinate system, are generated from the recorded data or at least a portion of the recorded data. Furthermore, calibration parameters for the robot kinematic system are derived from these recorded data or at least a portion of these recorded data.

In order to calibrate a robot kinematic system on the basis of a reference object, the reference object must be calibrated with high accuracy. This may be achieved for example by virtue of the reference object being calibrated beforehand in a calibration laboratory. If the reference object does not remain calibrated stably over the long term, regular calibration is necessary in order to ensure lasting accuracy. The advantage of the method according to an aspect of the disclosure is that the reference object is calibrated with high accuracy during the method according to an aspect of the disclosure through the generation of calibration data, and the complexity of a preliminary calibration and long-term stability is thus dispensed with.

Influencing variables, such as for example gravitational alignment (substep b) or substep c)) of the reference object or ambient temperature, may also be taken into account here. It is thus accordingly possible for example to carry out the first step at different ambient temperatures and to generate the calibration data or the references of the recorded recognizable features of the at least one reference object in a temperature-dependent manner in a coordinate system, with it being necessary to take into account that enough recordings of the recognizable features of the at least one reference object are generated at the different ambient temperatures. On account of the existing temperature dependence of the references of the recorded recognizable features of the at least one reference object, this may lead to improved ambient temperature-dependent calibration of the robot kinematic system.

Since the requirement for long-term stability of the reference object is reduced, it is possible to use a lightweight reference object fastened to a robot kinematic system, as a result of which the load capacity on the robot kinematic system can be reduced, in particular in comparison with a 3D digitizer attached to the robot kinematic system. Furthermore, if the reference object is fastened to the robot kinematic system and not the 3D digitizer or the camera, it is possible to dispense with wiring along the robot kinematic system.

Calibration data are generated and calibration parameters are derived in two independent steps. The calibration data are first generated, and, in a separate step, the calibration parameters are derived on the basis of the previously generated calibration data.

The newly determined calibration parameters may then be used to determine the pose of a 3D digitizer more accurately and thus measure a measurement object more accurately.

Furthermore, the newly determined calibration parameters also enable more accurate alignment of a measurement object with respect to the calibrated robot kinematic system.

The abovementioned object is thus achieved in its entirety.

According to a further exemplary embodiment, the 3D digitizer is a triangulation sensor, in particular a triangulation sensor with structured light projection.

The advantage of triangulation sensors is that they can determine 3D data very accurately and may also be realized relatively easily, for example by combining two cameras or one camera and a projector.

According to a further exemplary embodiment, the data for generating the calibration data and for deriving the calibration parameters may be different, identical, or partially identical.

Thus, for example, to generate calibration data, it may be helpful to use only data that have been recorded with a high-resolution camera and, to derive the calibration parameters, to use only data that have been recorded with the 3D digitizer, meaning that they are completely different. However, it may also be helpful for example to select poses such that the recorded data are suitable both for generating calibration data and for deriving calibration parameters, and the datasets are thus suitable for generating calibration data and for deriving calibration parameters, and they may thus be completely or at least partially identical. This advantageously makes it possible to reduce the time needed to record the data.

According to a further exemplary embodiment, a scale-defining element is present on the reference object and/or a robot link itself is a scale-defining element.

A scale-defining element is advantageous in order to be able to define the distances between the recognizable features in absolute terms, and not just in relative terms. In particular, if only 2D data are present, the distances between the recognizable features of the reference object are scalable if there is no fixed reference to a scale-defining element. The scale-defining element is for example a stable precision body. It is calibrated with high accuracy, usually with a tactile coordinate measuring machine, and consists of a material that hardly expands, ideally does not expand at all, in the event of a temperature change. The precision bodies are usually simple shapes of scale bar, such as for example a ball bar. The advantage is that, by generating the calibration data, the accuracy of the precision body is transferred to the reference object, which has a relatively complex structure, without the reference object itself having to be calibrated with high accuracy (for example in tactile fashion). However, a scale-defining element may also be an exactly measured distance between two recognizable features of the reference object.

According to a further exemplary embodiment, the recognizable features of the reference object are correlated in absolute terms by at least one absolute measurement with the 3D digitizer, wherein the 3D digitizer itself is thus the scale-defining element.

A calibrated 3D digitizer measures 3D data in absolute terms. A measurement of the recognizable features of the reference object using the 3D digitizer may accordingly be used to determine the distances between the recognizable features of the reference object, which may be present only in relative terms, in absolute terms. This advantageously makes it possible to dispense with a scale-defining element on the reference object.

According to a further exemplary embodiment, at least a portion of the local data of the recognizable features of the reference object that are present in the local reference coordinate system of the 3D digitizer and/or that are present in the local reference coordinate system of the camera are transferred into a global reference coordinate system.

To transfer or transform the local data of the recognizable features of the reference object (actual observations) into a global coordinate system, it is helpful to know the pose of the 3D digitizer attached to the end effector and/or of the camera attached to the end effector or of the reference object attached to the end effector. This results from the forward kinematics of the robot kinematic system and the relationship between the 3D digitizer and/or camera or reference object and the end effector. The forward kinematics, or else forward transformation, is the function that describes the position and orientation of the end effector, and also individual robot links in a given coordinate system, as a function of the robot configuration, which is given in the axis space (that is to say for example angular positions of rotary joints or linear positions of linear axes). To do this, the coordinate transformations for example of the individual robot links must be known. Nominally, these coordinate transformations for a given robot are known for example from data sheets, technical drawings, CAD data, given Denavit-Hartenberg parameters, or the like. The local data present in the local reference coordinate system of the 3D digitizer or of the camera relate for example to the position and orientation of the camera sensors. In the case of a triangulation sensor, this is predefined for example by the calibration of the triangulation sensor. The lengths and angles necessary for the transformation between the local reference coordinate system of the camera sensor and the coordinate system of the end effector may therefore be read nominally for example from the CAD data of the 3D digitizer and/or of the camera and any necessary adapters between the 3D digitizer and the end effector. Likewise, for example, CAD data of the reference object may also be used to establish a relationship between the end effector and the recognizable features of a reference object fastened to the end effector.

The calculation of the forward kinematics from these nominally known values (that is to say values not aligned with reality by any kind of calibration) is referred to hereinafter as “nominal forward kinematics”. However, due to, for example, geometric inaccuracies, elastic or thermal deformations or inaccuracies in the determination of the axis angles or lengths of the robot links, the accuracy of the position determination of the 3D digitizer and/or of the camera or of the reference object on the robot kinematic system is usually not sufficient. The nominal forward kinematics thus differ from the real ones.

The data present in the global coordinate system after the transformation are then used as starting values for subsequent optimization methods. The transformation into a global coordinate system with the forward kinematics makes it more likely to find a better extremum of the optimization methods.

According to a further exemplary embodiment, the calibration data of the recorded recognizable features of the reference object are generated and the calibration parameters of the robot kinematic system are derived, and optionally the calibration parameters of the 3D digitizer or of the camera are adapted, in such a way that the deviations between the coordinates of the recorded recognizable features of the reference object and the coordinates of the recognizable features of the reference object as calculated from a mathematical model are minimized.

In this case, a deviation may be for example a deviation of the position and/or a deviation of the orientation of the recognizable features of the reference object.

According to the method according to an aspect of the disclosure, a distinction is accordingly made between two parts. The first part is an optimization method for generating the calibration data with the data, provided for this purpose, for generating the calibration data, for example in accordance with a mathematical model using bundle adjustment in accordance with Luhmann, Robson, Kyle, Boehm, Close Range Photogrammetry and 3D Imaging, Second Edition, chapter 4, ISBN 978-3-1110-2986-3, and the second part is an optimization method for deriving the calibration parameters of the robot kinematic system in such a way that the deviations between the recorded recognizable features of the reference object and the recognizable features of the reference object correlated from the calibration data are minimized. This may be done for example in accordance with a mathematical model containing the calibration parameters of the robot kinematic system, using methods for solving a nonlinear optimization problem according to Nocedal, Wright, Numerical Optimization, Second Edition, ISBN 978-1-4939-3711-0.

In this case, the second part takes place after the first part. There are therefore two steps carried out in succession. In a further part or in combination with one of the first two parts, the calibration parameters of the 3D digitizer and/or of the camera may also be adapted if necessary, if a scale-defining element is captured by the 3D digitizer and/or the camera (see Luhmann, Robson, Kyle, Boehm, Close Range Photogrammetry and 3D Imaging, Second Edition, ISBN 978-3-1110-2986-3). In a further part or in combination with the bundle adjustment, the calibration parameters of the 3D digitizer and/or of the camera may also be adapted if necessary without a scale-defining element being captured by the 3D digitizer and/or the camera, if one of the robot links and thus part of the robot kinematic system itself is the scale-defining element. Likewise, in a further part or in combination with one of the first two parts, if necessary, scale-independent calibration parameters of the 3D digitizer and/or of the camera may also be adapted without a scale-defining element being captured, if the scale-dependent parameters of the calibration of the 3D digitizer and/or of the camera have been captured beforehand with the aid of a scale-defining element.

The method according to an aspect of the disclosure may thus be used to calibrate a robot kinematic system, to calibrate the reference object and if necessary also to calibrate the 3D digitizer or the camera.

The minimization advantageously provides an ideal solution to the optimization problems.

While the optimization methods and the identification of the calibration parameters may be formulated with the aid of the forward kinematics, it is just as possible to establish an equivalent optimization problem with the aid of the inverse kinematics.

According to a further exemplary embodiment, the calibration parameters of the robot kinematic system are geometric and/or elastic and/or thermal calibration parameters and/or calibration parameters of the robot kinematic system that take into account the configuration of the robot kinematic system, and/or calibration parameters that take into account the direction of approach, and/or calibration parameters of the characteristic of the or calibration parameters for determining the error curves of the length or angle measurement technology of the robot kinematic system and/or calibration parameters that characterize the play of individual or all axes of the robot kinematic system and/or calibration parameters that describe the dependence of the robot kinematic system on other variables, which may for example be recorded using sensors or be calculated on the basis of the existing data.

Depending on the type of a robot kinematic system and depending on the ambient conditions of the robot kinematic system and depending on the type of 3D digitizer or camera and reference object, it is useful to use different combinations of calibration parameters for the optimization.

However, the method according to an aspect of the disclosure is not restricted to these calibration parameters, and may be supplemented and combined with other parameters.

According to a further exemplary embodiment, the calibration parameters are used to determine the pose of the end effector and/or to align the end effector on the basis of the parameters.

The adapted calibration parameters resulting from the optimization method may be used to place the end effector of the robot kinematic system more accurately. This is expedient if the measurement of a measurement object takes place after the robot kinematic system has been calibrated. However, the calibration parameters may also be used to accurately determine a pose of the end effector. It is thus possible, for example, to use an inexpensive robot kinematic system the approach accuracy of which into a certain pose is low for mechanical reasons, but the pose of which can nevertheless be determined accurately through the adapted calibration parameters. Furthermore, it is therefore also possible to subsequently correct the poses of a measurement. If a 3D digitizer or a camera is attached to the robot kinematic system and these are also used as measurement sensors, the forward kinematics already contain the transformation from the global reference coordinate system to the local reference coordinate system of the 3D digitizer or camera. No additional hand-eye calibration is thus necessary.

According to a further exemplary embodiment, 3D digitizers and/or cameras and/or reference objects are fastened to a plurality of robot kinematic systems, and at least one of the robot kinematic systems is calibrated in accordance with the method according to an aspect of the disclosure.

By way of example, a combination with two or more robot kinematic systems with a 3D digitizer and a camera in each case is thus possible. These are used to measure the same reference object or different reference objects and its or their recognizable features in order to carry out the method according to the disclosure.

By way of example, a combination with two or more robot kinematic systems each with a reference object is also possible. In this case, the recognizable features of the reference objects are recorded by a 3D digitizer and/or a camera which is fixed and located in the surroundings of the robot kinematic system, while the reference objects are brought into different relative poses with respect thereto.

A further exemplary combination may be that some robot kinematic systems are equipped with a 3D digitizer, and some robot kinematic systems are equipped with a camera, and a robot kinematic system or some robot kinematic systems are equipped with a reference object, and these generate data for example according to substep c).

A constellation of a plurality of robot kinematic systems is likewise possible, in which one, a plurality of, or all robot kinematic systems are provided both with a 3D digitizer and/or a camera and with a reference object. The reference object may be attached to the robot kinematic system at any desired location.

With a combination including a plurality of robot kinematic systems, it is possible for these to be calibrated simultaneously. It is also possible to calibrate an uncalibrated robot kinematic system with a calibrated robot kinematic system. The respective robot kinematic systems may expediently be moved via a controller that controls all robot kinematic systems.

In principle, it is possible to realize various combinations of robot kinematic systems with 3D digitizers, cameras and reference objects in accordance with the method according to an aspect of the disclosure.

According to a further exemplary embodiment, the robot kinematic system or at least one of the robot kinematic systems is a rotary table.

A rotary table is particularly advantageous if 3D data are to be determined not only on the front face of a measurement object, but also on the sides and/or on the back face, and the 3D digitizer is fixed statically in the surroundings or a further robot kinematic system cannot reach the sides or the back face of the measurement object, this however being made possible by the rotary table.

The rotary table may be calibrated individually or with a further robot kinematic system, for example a six-axis robot.

According to a further exemplary embodiment, the robot kinematic systems are calibrated relative to one another.

If for example two or more 3D digitizers fastened to robot kinematic systems measure the same reference object fixed in the surroundings, then this has the advantage that the coordinate systems of the end effectors of the respective robot kinematic systems can be transferred into a common global reference coordinate system. This likewise works for the combination with two or more reference objects attached to robot kinematic systems, and also for the combination with a reference object fastened to a first robot kinematic system and a 3D digitizer fastened to a second robot kinematic system.

This means, for example in relation to the measurement of a measurement object, that it is possible to use two or more robot kinematic systems with 3D digitizers fastened to each thereof and it is possible to represent the surface data (3D data) of the measurement object of the respective 3D digitizers in a common global reference coordinate system.

It is also possible to calibrate entire series of robot kinematic systems and to transfer them into a common reference coordinate system.

According to a further exemplary embodiment, in addition to a 3D digitizer and/or camera and/or reference object, one or more further tools are fastened to the robot kinematic system and/or the 3D digitizer and/or the camera and/or the reference object on the robot kinematic system are replaced by one or more tools.

It is thereby possible for the method according to an aspect of the disclosure to be used not only for 3D coordinate metrology, but also for further robot kinematic tasks.

It is furthermore also conceivable, for example, for the reference object attached to the robot kinematic system for the calibration to be replaced by a measurement object and for surface data of the measurement object in different poses to then be generated with the 3D digitizer. In this case, it is possible to move both the robot kinematic system carrying the measurement object and, if the 3D digitizer is fastened to a robot kinematic system, the robot kinematic system carrying the 3D digitizer.

According to a further exemplary embodiment, the reference object is configured such that the recognizable features are located on a separate body and/or a wall provided with recognizable features and/or on a further robot kinematic system and/or on one or more arbitrary links of a robot kinematic system and/or on a 3D digitizer or a camera and/or on a tool and/or on a measurement object and/or around a measurement object.

Depending on the application, configuration, and ambient conditions of a robot kinematic system, it is advantageous to create a reference object with a specific arrangement of the recognizable features for the method according to an aspect of the disclosure.

In this case, the reference object may be a separate body. It may also be for example a wall provided with recognizable features, as described in EP 2 489 977 B1.

The reference object may also be located on a further robot kinematic system, in which case it may both be attached to any robot link and extend over one or more links of the further robot kinematic system. It may also be located on the end effector of the further robot kinematic system or on a tool fastened to the end effector. The reference object may consist of multiple partial reference objects. The partial reference objects may be constructed so as to be spatially separate from one another. The reference object may also be part of the 3D digitizer. The reference object is normally an object separate from the measurement object. However, a combination of both objects is likewise possible.

According to a further exemplary embodiment, the recognizable features are optical markers that actively light up and/or are passively illuminated, and/or features recognizable in two dimensions having a unique 2D geometry and/or features recognizable in three dimensions having a unique 3D geometry.

Depending on the type and application of a 3D digitizer or camera, it is advantageous to use corresponding recognizable features.

Features recognizable in two dimensions may be for example patterns, circles, holes, spheres, edges or corners; features recognizable in three dimensions may be for example spheres, cylinders, cones, etc.

According to a further exemplary embodiment, the camera is removed from the robot kinematic system when it is not being used.

This has the advantage of improving the accessibility of the 3D digitizer to the reference object and to a measurement object. Thus, for example, if the measurement object is an automobile chassis, it is much easier also to carry out a measurement in the automobile chassis if the camera has been removed from the robot kinematic system for the measurement process.

It goes without saying that the abovementioned features and the features still to be explained below may be used not only in the respectively indicated combination but also on their own or in other combinations, without departing from the scope of the present disclosure.

Moreover, it goes without saying that the features defined in the dependent claims for the method for calibrating the robot kinematic systems may also be used in the same way or equivalently as apparatus features for the method according to the disclosure, without being listed again separately here as apparatus features.

The indefinite term “a”/“an” is to be understood within the meaning of the present disclosure not as a numeral, but as an indefinite term in the sense of “at least one”. Consequently, the features specified by “an element” also include within their meaning multiple such elements, such as for example multiple robot kinematic systems or a robot kinematic system with one or more 3D digitizers, cameras or reference objects. In addition, further, other elements are not ruled out.

### BRIEF DESCRIPTION OF THE DRAWINGS

The disclosure will now be described with reference to the drawings wherein:

FIG. 1 shows a flowchart for illustrating a method according to an exemplary embodiment of the disclosure;

FIG. 2 shows a schematic illustration of an apparatus according to a first exemplary embodiment of the disclosure;

FIG. 3 shows a schematic illustration of an apparatus according to a second exemplary embodiment of the disclosure;

FIG. 4 shows a schematic illustration of an apparatus according to a third exemplary embodiment of the disclosure;

FIG. 5 shows a schematic illustration of an apparatus for measuring a measurement object according to an exemplary embodiment of the disclosure;

FIG. 6 shows a further schematic illustration of an apparatus with a plurality of robot kinematic systems according to an exemplary embodiment of the disclosure; and

FIG. 7 shows a further schematic illustration of an apparatus with a rotary table and a six-axis robot according to an exemplary embodiment of the disclosure.

### DESCRIPTION OF EXEMPLARY EMBODIMENTS

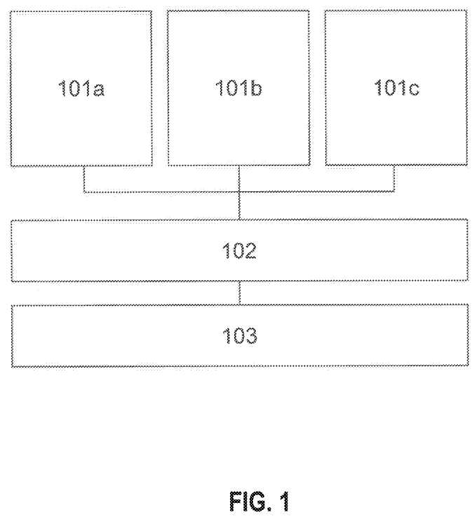

In a first variant of the method according to a first exemplary embodiment of the disclosure, in a substep 101a (FIG. 1), a 3D digitizer 2 is fastened to a first robot kinematic system 1a and a camera 4, wherein the camera 4 is fastened to the first robot kinematic system 1a or to a further second robot kinematic system 1b, and a reference object 7, having recognizable features 8, which is located in the surroundings of the robot kinematic system 1a or in the surroundings of the robot kinematic systems 1a, 1b, is stationary for the recordings. The 3D digitizer 2, the camera 4, and the reference object 7 are brought into different relative poses with respect to one another by the robot kinematic system 1a or the robot kinematic systems 1a, 1b, and data of the recognizable features 8 of the reference object 7 are recorded by the 3D digitizer 2 and by the camera 4 in the different relative poses.

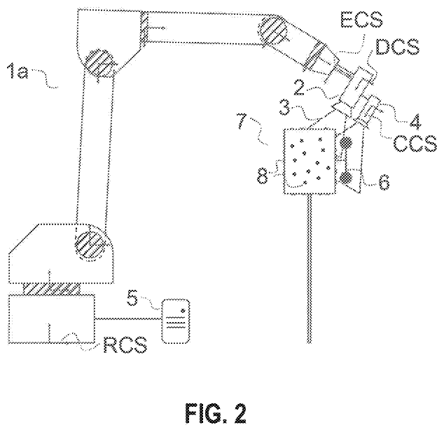

An apparatus according to a first exemplary embodiment is shown in FIG. 2. The apparatus has a 3D digitizer 2 which is fastened to a robot kinematic system 1a and which has a measurement volume 3, and a camera 4 fastened to a robot kinematic system 1a, and a reference object 7, which contains recognizable features 8, and which is located in the surroundings of the robot kinematic system 1a. In this exemplary embodiment, the robot kinematic system 1a is a six-axis robot. The axes are each identified by hatching. The apparatus, as well as the exemplary embodiments mentioned below, may be controlled for example with a computer 5. The computer includes a non-transitory computer-readable storage medium on which a computer program including instructions is stored, which when the computer program is executed by a processor, causes the processor and/or further processors to carry out the method according to an aspect of the disclosure.

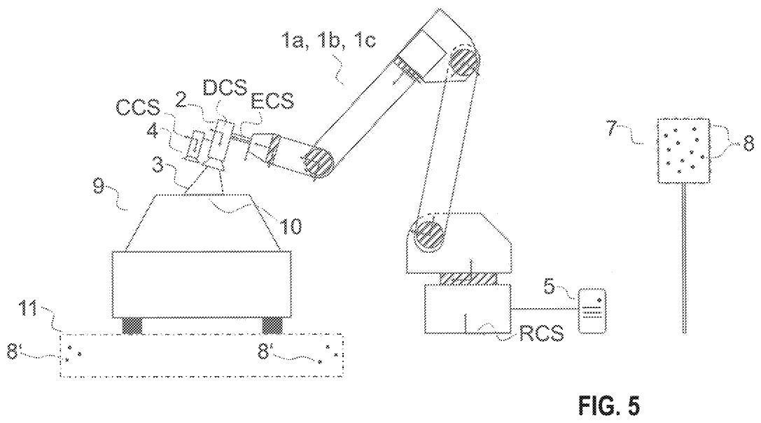

The camera 4 may be disassembled after the recordings required by the camera 4 have been carried out. This has the advantage of improving the accessibility of the 3D digitizer 2 to the reference object 7 or to a measurement object 9 (FIG. 5).

In the method according to a second exemplary embodiment of the disclosure, in a substep 101b, a 3D digitizer 2 located and fixed in the surroundings of a robot kinematic system 1a and a camera 4 fixed in the surroundings and a reference object 7, having recognizable features 8, which is fastened to the robot kinematic system 1a are brought into different relative poses with respect to one another by the robot kinematic system 1a, and data of the recognizable features 8 of the reference object 7 are recorded by the at least one 3D digitizer 2 and the camera 4 in these different relative poses.

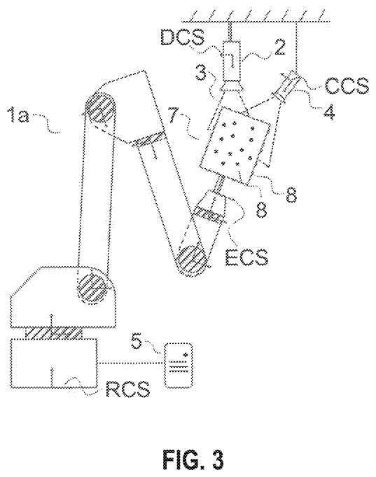

An apparatus according to a second exemplary embodiment is shown in FIG. 3. The apparatus has a reference object 7, containing recognizable features 8, which is fastened to a robot kinematic system 1a, and a 3D digitizer 2 located and fixed in the surroundings of the robot kinematic system 1a, and a camera 4 located in the surroundings of the robot kinematic system 1a.

In the method according to a third exemplary embodiment of the disclosure, in a substep 101c, a reference object 7, having recognizable features 8, which is fastened to a first robot kinematic system 1a, and a 3D digitizer 2 which is fastened to a second robot kinematic system 1b or to a third robot kinematic system 1c, and/or a camera 4 which is fastened to a second robot kinematic system 1b or to a third robot kinematic system 1c, are brought into different relative poses with respect to one another by the robot kinematic system 1a and the robot kinematic system 1b and/or 1c, and data of the recognizable features 8 of the reference object 7 are recorded by the 3D digitizer 2 and/or the camera 4 in these different relative poses.

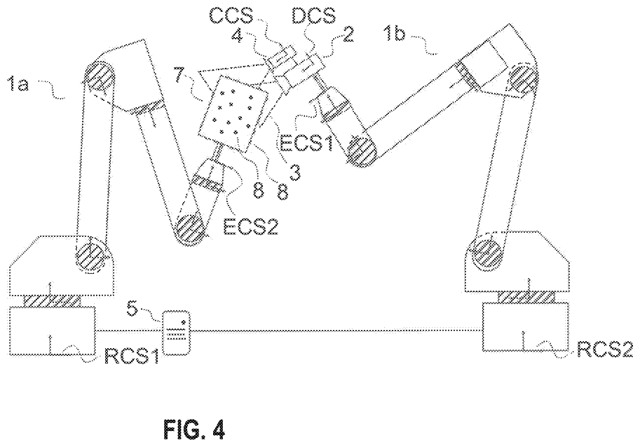

An apparatus according to a third exemplary embodiment is shown in FIG. 4. The apparatus has a reference object 7 fastened to a robot kinematic system 1a and a 3D digitizer 2 which is fastened to a robot kinematic system 1b and which has a measurement volume 3, and a camera 4 fastened to the robot kinematic system 1b.

In substeps 101a, 101b, 101c, which belong to a first step, data that are evaluated in the next steps are recorded.

In a further second step 102 (FIG. 1), calibration data, which correlate the recorded features 8 of the reference object 7 in a coordinate system, are generated at least from a portion of the recorded data.

In the case of substeps 101a and 101b, the calibration data is generated, with data consisting at least partially of data that were generated by the camera 4. For substep 101c, the selection may be made as desired.

In order to calibrate a robot kinematic system 1a, 1b, 1c with respect to the reference object 7, the reference object 7 must be calibrated with high accuracy. This may be achieved for example by virtue of the reference object 7 having been calibrated beforehand in a calibration laboratory. If the reference object 7 does not remain calibrated stably over the long term, regular calibration is necessary in order to ensure lasting accuracy. The advantage of the method according to an aspect of the disclosure is then that the reference object 7 is calibrated with high accuracy during the method according to an aspect of the disclosure through the generation of calibration data, and the complexity of a preliminary calibration and long-term stability is thus dispensed with.

The reference object 7 may be configured such that the recognizable features 8 are located on a separate body and/or a wall provided with recognizable features 8 and/or on a further robot kinematic system 1a, 1b, 1c and/or on one or more arbitrary links of a robot kinematic system 1a, 1b, 1c and/or on a 3D digitizer 2 or a camera 4 and/or on a tool and/or on a measurement object 9 and/or around a measurement object 9.

The recognizable features 8 may be optical markers which actively light up and/or are passively illuminated, and/or features 8 recognizable in two dimensions having a unique 2D geometry and/or features 8 recognizable in three dimensions having a unique 3D geometry.

A scale-defining element 6 can be applied to the reference object 7 in order to be able to define the distances between the recognizable features 8 in absolute terms, and not just in relative terms. The scale-defining element 6 is shown in FIG. 2, but could just as well be present in FIG. 3, 4, 6, or 7 for the apparatus according to the second and third exemplary embodiment, respectively, in conjunction with the method according to an aspect of the disclosure. The scale-defining element 6 is for example a stable precision body. It is calibrated with high accuracy, typically with a tactile coordinate measuring machine, and consists of or includes a material that hardly expands, ideally does not expand at all, in the event of a temperature change. The precision bodies are usually simple shapes of length gages, such as for example a ball bar. The advantage is that, by generating the calibration data, the accuracy of the precision body is transferred to the reference object 7, which has a relatively complex structure, without the reference object 7 itself having to be calibrated with high accuracy (for example in tactile fashion).

A scale-defining element 6 may also be given by the, or one of the, 3D digitizer(s) 2, as shown in FIG. 3, 4, 6, or 7, by virtue of the 3D digitizer 2 providing at least one recording of 3D data. An additional scale-defining element 6, as shown in FIG. 2, is thus not absolutely necessary. However, the additional scale-defining element 6 could also be omitted in FIG. 2, that is to say the apparatus according to the first exemplary embodiment of the method according to an aspect of the disclosure, if the 3D digitizer 2 is used as a scale-defining element 6. The 3D digitizer 2 may be the scale-defining element 6, since it uses at least one 3D data recording to measure the distances between the recognizable features 8 of the reference object 7 in absolute terms based on the calibration of the 3D digitizer 2. The recognizable features 8 of the reference object 7, which may be correlated from 2D data only relatively when the calibration data are generated, may accordingly be correlated in absolute terms by combination with at least one recording of 3D data of the 3D digitizer 2. It would likewise be conceivable for one of the robot links itself to be the scale-defining element. In this case, no further scale-defining element would be required for the method according to an aspect of the disclosure.

The data recorded for the purpose of generating the calibration data may originate from the 3D digitizer 2 and/or the camera 4, wherein, for substeps 101a and 101b, at least a portion of the data is generated by the camera 4.

Typically, a high-resolution digital camera is used to generate the calibration data, wherein the digital camera is brought into a large number of different relative poses with respect to the reference object 7 in order to record images of the recognizable features 8 of the reference object 7. From the images recorded in these poses, bundle adjustment (in accordance with Luhmann, Robson, Kyle, Boehm, Close Range Photogrammetry and 3D Imaging, Second Edition, chapter 4, ISBN 978-3-1110-2986-3) may be used to correlate the recognizable features 8 of a reference object 7 in a coordinate system. This is an optimization method for generating the calibration data within step 102.

Typically, the bundle adjustment method uses 2D data. However, it is likewise conceivable to use 3D data of a 3D digitizer 2.

In another third step 103 (FIG. 1), the calibration parameters of the robot kinematic system 1a and/or 1b and/or 1c are derived. To derive the calibration parameters of the robot kinematic system 1a, 1b, 1c, it is possible, on the one hand, to use 2D data that are recorded for example with a camera 4. Advantageously, it is in particular also possible to use 3D data that are recorded by a 3D digitizer 2, in particular a triangulation sensor, since triangulation sensors can determine 3D data very accurately and can also be realized relatively easily, for example by the combination of two cameras or one camera and a projector. When applying substeps 101a and 101b, at least a portion of the data consists of or includes data that were generated by the 3D digitizer 2.

By way of example, a stripe projection system may be used as triangulation sensor. This consists of or includes, for example, two cameras and a projector for projecting fringe images. In this case, homologous image points, that is to say points that image the same object point of a surface in the two cameras, are triangulated, and the object point is thus determined in space, that is to say a 3D coordinate is generated in the local reference coordinate system DCS of the stripe projection system with respect to the object point. Since a stripe projection system records a plurality of homologous image points, it is an area sensor. It is thus also possible to generate 3D data of multiple recognizable features 8 of a reference object 7 at a pose of the stripe projection system. On account of the high accuracy of the 3D data of the stripe projection system in all three spatial dimensions, the pose of the stripe projection system in relation to the reference object 7 can be determined with very high accuracy, and the robot kinematic system 1a, 1b, 1c can thus be calibrated with very high accuracy. (See also Luhmann, Robson, Kyle, Boehm, Close Range Photogrammetry and 3D Imaging, Second Edition, chapter 6, ISBN 978-3-1110-2986-3).

In this case, it may be expedient, in order to record the recognizable features 8 of the reference object 7 with the 3D digitizer 2 and/or the camera 4, to approach those poses that are suitable for calibrating the robot kinematic system 1a, 1b, 1c. Use is made here for example of poses that cover as many axis angles as possible or poses that generate different gravitational effects on the robot links or axes of the robot kinematic system 1a, 1b, 1c, while it may be expedient, for generating calibration data, to approach poses in such a way that the recognizable features 8 of the reference object 7 are calibrated accurately.

However, it may also be the case that use is made of poses that are suitable both for generating calibration data and for deriving calibration parameters of the robot kinematic system 1a, 1b, 1c. The data recorded in this case may then be identical for the generation of the calibration data and for the derivation of the calibration parameters.

Generally speaking, the data for generating the calibration data and for deriving the calibration parameters may be different, identical, or partially identical. Furthermore, the chronological order in which the data are recorded is also irrelevant.

A portion of the data of the recognizable features 8 of the reference object 7 present in the local reference coordinate system DCS of the 3D digitizer 2 or in the local reference coordinate system CCS of the camera 4 may be transformed into a global reference coordinate system, for example RCS, RCS1 or RCS2, RCS3 or RCS4, wherein other reference coordinate systems, including non-global reference coordinate systems, are also conceivable. This concerns in particular the portion of the data used to derive the calibration parameters.

To transform the local data (actual observations) into a global coordinate system, for example RCS, RCS1 or RCS2, RCS3 or RCS4, it is helpful to know the pose of the 3D digitizer 2 attached to the end effector and/or of the camera 4 attached to the end effector or of the reference object 7 attached to the end effector. This results from the forward kinematics of the robot kinematic system 1a, 1b, 1c and the relationship between the 3D digitizer 2 and/or camera 4 or reference object 7 and the end effector. The forward kinematics, or else forward transformation, is the function that describes the position and orientation of the end effector or its coordinate system ECS, and also individual robot links in a given coordinate system, for example RCS, RCS1 or RCS2, RCS3 or RCS4, as a function of the robot configuration, which is given in the axis space (that is to say for example angular positions of rotary joints or linear positions of linear axes). To do this, the coordinate transformations of the individual robot links must be known. Nominally, these coordinate transformations for a given robot are known for example from data sheets, technical drawings, CAD data, given Denavit-Hartenberg parameters, or the like. The data present in the local reference coordinate system of the 3D digitizer 2 or of the camera 4 relate for example to the position and orientation of the camera sensors. In the case of a triangulation sensor, this is predefined by the calibration of the triangulation sensor. The lengths and angles necessary for the transformation between the local reference coordinate system (DCS, CCS) of the camera sensor and the coordinate system of the end effector (ECS) may therefore be read nominally for example from the CAD data of the 3D digitizer 2 and/or of the camera 4 and any necessary adapters between the 3D digitizer 2 and/or camera 4 and the end effector. Likewise, CAD data of the reference object 7 may also be used to establish a relationship between the end effector and the recognizable features 8 of a reference object 7 fastened to the end effector. The relationship between RCS1 and RCS2 or between RCS3 and RCS4 may for example likewise be taken from CAD data or have been measured.

With regard to carrying out coordinate transformations, reference is made to Luhmann, Robson, Kyle, Boehm, Close Range Photogrammetry and 3D Imaging, Second Edition, chapter 2, ISBN 978-3-1110-2986-3.

The calculation of the forward kinematics from these nominally known values (that is to say values not aligned with reality by any kind of calibration) is referred to hereinafter as “nominal forward kinematics”. However, due to, for example, geometric inaccuracies, elastic or thermal deformations or inaccuracies in the determination of the axis angles or lengths of the robot links, the accuracy of the position determination of the 3D digitizer 2 and/or of the camera 4 or of the reference object 7 on the robot kinematic system 1a, 1b, 1c is usually not sufficient. The nominal forward kinematics thus differ from the real ones.

The data present after the transformation in the global coordinate system, for example RCS, RCS1 or RCS2, RCS3 or RCS4, are then used as starting values for a subsequent optimization method. The transformation into a global coordinate system RCS, RCS1 or RCS2, RCS3 or RCS4 with the forward kinematics makes it more likely to find a better extremum of the optimization method.

In the optimization method, the generation of the calibration data of the recorded recognizable features 8 of the reference object 7 and the derivation of the calibration parameters of the robot kinematic system 1a, 1b, 1c, and optionally an adaptation of the calibration parameters of the 3D digitizer 2 or of the camera 4, may be adapted in such a way that the deviations between the coordinates of the recorded recognizable features 8 of the reference object 7 and the coordinates of the recognizable features 8 of the reference object 7 as calculated from a mathematical model are minimized.

In this case, a deviation may be for example a deviation of the position and/or a deviation of the orientation of the recognizable features 8 of the reference object 7.

According to an aspect of the method according to the disclosure, a distinction is accordingly made between two parts. The first part is an optimization method for generating the calibration data using the data, provided for this purpose, for generating the calibration data, for example in accordance with a mathematical model using bundle adjustment in accordance with Luhmann, Robson, Kyle, Boehm, Close Range Photogrammetry and 3D Imaging, Second Edition, chapter 4, ISBN 978-3-1110-2986-3, and the second part is an optimization method for deriving the calibration parameters of the robot kinematic system 1a, 1b, 1c in such a way that the deviations between the recorded recognizable features 8 of the reference object 7 and the recognizable features 8 of the reference object 7 correlated from the calibration data are minimized. This may be done, for example, in accordance with a mathematical model containing the calibration parameters of the robot kinematic system, using methods for solving a nonlinear optimization problem according to Nocedal, Wright, Numerical Optimization, Second Edition, ISBN 978-1-4939-3711-0.

In this case, the second part takes place after the first part. There are therefore two steps carried out in succession. In a further part or in combination with the bundle adjustment, the calibration parameters of the 3D digitizer 2 and/or of the camera 4 may also be adapted if necessary, if a scale-defining element 6 is captured by the 3D digitizer 2 and/or the camera 4 (see Luhmann, Robson, Kyle, Boehm, Close Range Photogrammetry and 3D Imaging, Second Edition, ISBN 978-3-1110-2986-3). In a further part or in combination with the bundle adjustment, the calibration parameters of the 3D digitizer 2 and/or of the camera 4 may also be adapted if necessary without a scale-defining element 6 being captured by the 3D digitizer 2 and/or the camera 4, if one of the robot links and thus part of the robot kinematic system 1a, 1b, 1c itself is the scale-defining element 6. Likewise, in a further part or in combination with one of the first two parts, if necessary, scale-independent calibration parameters of the 3D digitizer 2 and/or of the camera 4 may also be adapted without a scale-defining element 6 being captured, if the scale-dependent parameters of the calibration of the 3D digitizer 2 and/or of the camera 4 have been captured beforehand with the aid of a scale-defining element 6.

The method according to an aspect of the disclosure may thus be used to calibrate the robot kinematic system 1a, 1b, 1c, to calibrate the reference object 7 and to calibrate the 3D digitizer 2 or the camera 4.

The minimization advantageously provides an ideal solution to the optimization problem.

By way of example, an optimization problem to be solved will be explained for substep A 101a, in which a 3D digitizer 2 and a camera 4 are fastened to the robot kinematic system 1a. In this case, let P_{LCS,i,j} contain the coordinates of the i-th recognizable feature 8 of the reference object 7 with respect to the j-th pose of the robot kinematic system 1a in the local reference coordinate system DCS of the 3D digitizer 2 or CCS of the camera 4. Let the forward kinematics be described by the axis value Jⱼ belonging to the j-th pose. Axis values may be for example an angle or a displacement between structural components of the robot kinematic system 1a. The coordinates P_{GCS,i,j} transformed into a global reference coordinate system, for example RCS, as a function of the calibration parameters p are given by applying a transformation function Fₚ, which may result for example from the successive execution of multiple transformations for the individual robot links.

P_{GCS,i,j}(p)=Fₚ(P_{LCS,i,j},Jⱼ) (1)

There is thus an optimization problem (2)

$${min}_{p} {\sum }_{i , j} {( {P}_{GCS , i , j} ( p ) - {Q}_{GCS , i} )}^{2} \qquad ( 2 )$$

to be solved, wherein Q_{GCS,i} are the coordinates of the i-th recognizable feature of the recognizable features 8 of the reference object 7 contained in the calibration data that were determined in the first part.

The minimization advantageously provides an ideal solution to the optimization problem.

The optimization methods and the identification of the calibration parameters may be formulated with the aid of the forward kinematics. However, it is just as possible to establish an equivalent optimization problem with the aid of inverse kinematics.

The calibration parameters of the robot kinematic system 1a, 1b, 1c may be for example geometric and/or elastic and/or thermal calibration parameters and/or calibration parameters of the robot kinematic system 1a, 1b, 1c that take into account the configuration of the robot kinematic system 1a, 1b, 1c, and/or calibration parameters that take into account the direction of approach, and/or calibration parameters of the characteristic of the or calibration parameters for determining the error curve of the length or angle measurement technology of the robot kinematic system 1a, 1b, 1c and/or calibration parameters that characterize the play of individual or all axes of the robot kinematic system 1a, 1b, 1c and/or calibration parameters that describe the dependence of the robot kinematic system 1a, 1b, 1c on other variables, which may for example be recorded using sensors or be calculated on the basis of the existing data.

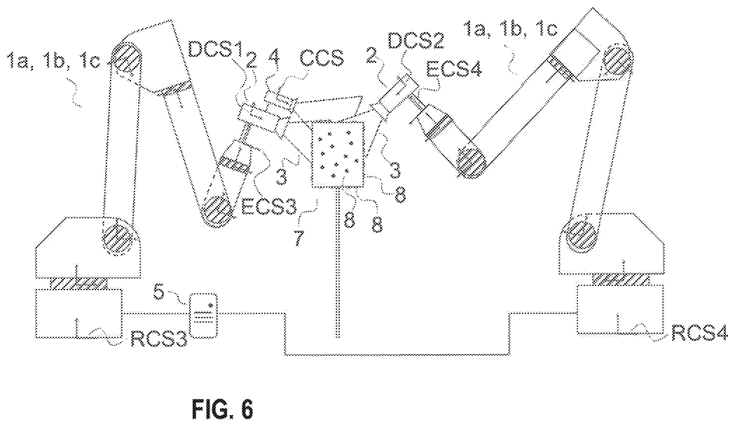

In this case, the distance and angular position of the two coordinate systems RCS1 and RCS2 (FIG. 4) or RCS3 and RCS4 (FIG. 6) with respect to one another may likewise be considered to be a calibration parameter of the robot kinematic system 1a, 1b, 1c.

Depending on the type of a robot kinematic system 1a, 1b, 1c and depending on the ambient conditions of the robot kinematic system 1a, 1b, 1c and depending on the type of 3D digitizer 2 or camera 4 and reference object 7, it is useful to use different combinations of calibration parameters for the optimization.

However, the method according to an aspect of the disclosure is not restricted to these calibration parameters, and may be supplemented and combined with other parameters.

The calibration parameters resulting from the optimization method may be used to determine the pose of the end effector and/or to align the end effector on the basis of the calibration parameters.

The adapted calibration parameters resulting from the optimization method may be used to place the end effector of the robot kinematic system 1a, 1b, 1c more accurately. This is expedient if the measurement of a measurement object 9 takes place after the robot kinematic system 1a, 1b, 1c has been calibrated. However, the calibration parameters may also be used to accurately determine a pose of the end effector. It is thus possible, for example, to use an inexpensive robot kinematic system 1a, 1b, 1c the approach accuracy of which into a certain pose is low for mechanical reasons, but the pose of which is nevertheless able to be determined accurately through the adapted calibration parameters. Furthermore, it is therefore also possible to subsequently correct the poses of a measurement. Accordingly, it is possible first to record data of the measurement object 9 with the 3D digitizer 2 in different poses of the 3D digitizer 2, and then to derive the calibration parameters of the robot kinematic system 1a, 1b, 1c on the basis of the method according to an aspect of the disclosure and to transfer the recorded data of the measurement object 9 into a global coordinate system, for example RCS, RCS1 or RCS2, RCS3 or RCS4, on the basis of the subsequently derived calibration parameters.

As shown in FIG. 5, it is thus possible to bring a 3D digitizer 2 fastened to a robot kinematic system 1a, 1b, 1c into different poses in order to measure the measurement object 9, and the 3D digitizer 2 can generate local 3D data in the reference coordinate system DCS of the 3D digitizer 2, and the local 3D data generated for the different poses may be transferred into a global coordinate system, for example RCS, on the basis of the robot kinematic system 1a, 1b, 1c calibrated in accordance with the method according to an aspect of the disclosure. Thus, during a measurement, the 3D data of a measurement object 9, in which a 3D digitizer 2 can capture only subregions 10 of the measurement object 9 with its measurement volume 3, can be determined more accurately as a whole through the precise transfer of the local 3D data into the global coordinate system RCS.

Furthermore, a measurement object 9 may be aligned with respect to the robot kinematic system 1a, 1b, 1c on the basis of recognizable features 8′ that are distributed on or around the measurement object 9 and are captured by a 3D digitizer 2 and/or camera 4 fastened to a robot kinematic system 1a, 1b, 1c, wherein the robot kinematic system 1a, 1b, 1c has been calibrated in accordance with the method according to an aspect of the disclosure. This is expedient for example if the measurement object 9 cannot be captured completely on account of its size and the limited arm length of the robot kinematic system 1a, 1b, 1c. As shown in FIG. 5, the measurement object 9 may be located for example on a mobile platform 11 that has recognizable features 8′, wherein the recognizable features 8′ may differ from the recognizable features 8. A measurement sequence may for example take place as follows:

Providing a measurement object 9 attached to a mobile platform 11;

Generating first 3D data by carrying out a first measurement of the recognizable features 8′ with the 3D digitizer 2 in the local reference coordinate system DCS of the 3D digitizer 2 and transforming the first 3D data into a global reference coordinate system RCS;

Generating second 3D data by carrying out a first measurement of the measurement object 9 with the 3D digitizer 2 fastened to the robot kinematic system 1a, 1b, 1c in different poses and, for each measurement in the corresponding pose, carrying out a transformation of the second 3D data measured in the local reference coordinate system DCS of the 3D digitizer 2 into the global reference coordinate system RCS;

Displacing the measurement object 9 with the mobile platform 11 in order to be able to measure the hitherto unreachable regions of the measurement object 9;

Generating third 3D data by carrying out a second measurement of the recognizable features 8′ with the 3D digitizer 2 in the local reference coordinate system DCS of the 3D digitizer 2 and transforming the third 3D data into a global reference coordinate system RCS;

Determining the displacement and the rotation of the mobile platform 11 in the global reference coordinate system RCS on the basis of the first and second 3D data of the recognizable features 8′ recorded in the first and second measurement; and

Generating fourth 3D data by carrying out a second measurement of the measurement object 9 with the 3D digitizer 2 fastened to the robot kinematic system 1a, 1b, 1c in different poses and, for each measurement in the corresponding pose, carrying out a transformation of the fourth 3D data measured in the local reference coordinate system DCS of the 3D digitizer 2 into the global reference coordinate system RCS, and displacing and rotating the second 3D data to match the fourth 3D data on the basis of the determined displacement and rotation of the mobile platform 11.

As an alternative to displacing the measurement object 9 on the mobile platform 11, it is also possible to additionally displace the robot kinematic system 1a, 1b, 1c, or to displace only the robot kinematic system 1a, 1b, 1c.

However, a mobile platform 11, provided for example that position data of the mobile platform 11 can be read out via the controller of the mobile platform 11, may itself also be a robot kinematic system 1a, 1b, 1c, and is calibrated in accordance with the method according to an aspect of the disclosure, such that the measured 3D data of the measurement object 9 are thereby transferred into a global reference coordinate system.

The methods and exemplary embodiments mentioned up to now may also be transferred to multiple robot kinematic systems 1a, 1b, 1c. Thus, for example, as shown in FIG. 6, it is possible for two 3D digitizers 2, with their reference coordinate systems DCS1 and DCS2, to be fastened to the end effectors, with reference coordinate systems ECS3 and ECS4, of a respective robot kinematic system 1a, 1b, 1c. If the same reference object 7 is calibrated, as shown in FIG. 6, then it is possible to measure the robot kinematic systems 1a, 1b, 1c relative to one another, that is to say they have a common coordinate system. The coordinate system RCS3 may thus be transferred into the coordinate system RCS4 and vice versa, since the pose of the reference object 7 in RCS3 and RCS4 results from the calibration of the robot kinematic systems 1a, 1b, 1c.

Generally speaking, the constructions shown in the exemplary applications are not restricted to one or two robot kinematic systems 1a, 1b, 1c. It is also possible to calibrate entire series of robot kinematic systems 1a, 1b, 1c and to transfer them into a common reference coordinate system.

However, this also means that a measurement object 9 may be measured with multiple 3D digitizers 2 on robot kinematic systems 1a, 1b, 1c, and the measurement data may be transferred into a common reference coordinate system, for example RCS1 or RCS2 or RCS3, etc.

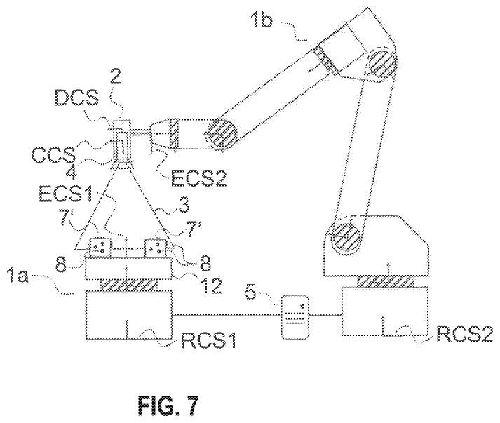

A further apparatus according to an exemplary embodiment is shown in FIG. 7. FIG. 7 shows a rotary table as the first robot kinematic system 1a and a six-axis robot as second robot kinematic system 1b. The robot kinematic systems 1a, 1b may be controlled separately or by a controller located for example in a computer 5, as shown in FIG. 7. If one of the robot kinematic systems 1a, 1b is already calibrated sufficiently well, it may be sufficient to calibrate the other robot kinematic system 1b, 1a in accordance with the present method in order to determine the position and orientation between the end effectors ECS1 and ECS2 or the position and orientation between CCS or DCS and ECS1. However, it is also possible for both robot kinematic systems 1a, 1b to be simultaneously calibrated, and calibrated relative to one another, in accordance with the present method, such that all calibration parameters of the robot kinematic system 1a, 1b are determined at once and the position and orientation of the two end effectors ECS1, ECS2 relative to one another or the position and orientation of CCS, DCS with respect to ECS1 are determined therefrom. In order to carry out the method according to the disclosure, the camera 4 is part of the 3D digitizer 2 in this example. In this case, in its dual function, it supplies 2D data, in particular for calibrating the reference object 7, which is represented here by two partial reference objects 7′ located on the rotary plate 12, on the one hand, and generates data for the 3D digitizer in order to calculate 3D data, which are used in particular to derive calibration parameters, on the other hand. The coordinate systems CCS and DCS may also be identical here.

To simultaneously calibrate both robot kinematic systems, that is to say the rotary table and the six-axis robot, the optimization problem (2) may be supplemented as follows. In this case, let P_{LCS,i,j} contain the coordinates of the i-th recognizable feature 8 of the reference object 7 with respect to the j-th pose between the robot kinematic system 1a and 1b in the local reference coordinate system DCS of the 3D digitizer 2 or CCS of the camera 4, and Q_{LCS,i} contain the coordinates of the i-th recognizable feature 8 of the reference object 7 in the local reference coordinate system of the reference object 7. Let the forward kinematics of the first robot kinematic system 1a be described by the axis values J_{1,j} belonging to the j-th pose. Let the forward kinematics of the second robot kinematic system 1b be described by the axis values J_{2,j} belonging to the j-th pose. Axis values may be for example angles between structural components of the respective robot kinematic system 1a or 1b. The coordinates Q_{GCS,i,j} transformed into a global reference coordinate system, for example RCS1, as a function of the calibration parameters q for robot kinematic system 1a are given by applying a transformation function F_{1,g}. The coordinates P_{GCS,i,j} transformed into a global reference coordinate system RCS1 as a function of the calibration parameters p for robot kinematic system 1b are given by applying a transformation function F_{2,p}, which may result for example from the successive execution of multiple transformations for the individual robot links of the robot kinematic system 1b. This then also contains for example the transformation from RCS2 to RCS1.

Q_{GCS,i,j}(q)=F_{1,p}(Q_{LCS,i,j},J_{1,j}) (3)

P_{GCS,i,j}(p)=F_{2,p}(P_{LCS,i,j},J_{2,j}) (4)

THERE is thus an optimization problem (5) to be solved.

$${min}_{p , q} {\sum }_{i , j} {( {P}_{GCS , i , j} ( p ) - {Q}_{GCS , i , j} ( q ) )}^{2} \qquad ( 5 )$$

It is pointed out here that the method according to an aspect of the disclosure may be applied not just to a 3D measurement. For instance, in addition to the 3D digitizer 2 and/or camera 4 and/or reference object 7, one or more further tools may be fastened to the robot kinematic systems 1a, 1b, 1c and/or the 3D digitizer 2 and/or camera 4 and/or reference object 7 on the robot kinematic systems 1a, 1b, 1c may be replaced by one or more tools, such that other tasks can also be carried out with the robot kinematic systems 1a, 1b, 1c.

It is also possible for example for the reference object 7 attached to the robot kinematic system 1a, 1b, 1c for the calibration to be replaced by a measurement object 9, and for surface data of the measurement object 9 in different poses to subsequently be generated with the 3D digitizer 2. In this case, it is possible to move both the robot kinematic system 1a, 1b, 1c carrying the measurement object 9 and, if the 3D digitizer 2 is fastened to a robot kinematic system 1a, 1b, 1c, the robot kinematic system 1a, 1b, 1c carrying the 3D digitizer 2.

It goes without saying that the exemplary embodiments shown here serve merely to schematically illustrate the principle and execution of the present disclosure. Various modifications of a functional and structural nature are possible without departing from the scope of the present disclosure.

### LIST OF REFERENCE NUMERALS

101a substep A
101b substep B
101c substep C
102 second step
103 third step
1a first robot kinetic system
1b second robot kinetic system
1c third robot kinetic system
2 3D digitizer
3 measurement volume
4 camera
5 computer
6 scale-defining element
7 reference object
8 recognizable features
9 measurement object
10 subregion
11 mobile platform
12 rotary plate
DCS, DCS1, DCS2 local reference coordinate systems
CCS reference coordinate system
ECS, ECS1, ECS2, ECS3, ECS4 end effector coordinate systems
RCS, RCS1, RCS2, RCS3, RCS4 global reference coordinate systems

What is claimed is:

1. A method for calibrating at least one robot kinematic system, the method comprising:
a first step comprising:
a first substep comprising:
fastening at least one 3D digitizer to a first robot kinematic system of the at least one robot kinematic system and fastening at least one camera to the first robot kinematic system or to a second robot kinematic system of the at least one robot kinematic system, wherein at least one reference object having recognizable features is located in the surroundings of the first robot kinematic system or in the surroundings of the first and second robot kinematic systems, which is stationary for the recordings,
bringing the at least one 3D digitizer and the at least one camera and the at least one reference object into different relative poses with respect to one another by the first robot kinematic system or the first and second robot kinematic systems, and
recording data of the recognizable features of the reference object by the at least one 3D digitizer and by the at least one camera in the different relative poses, or
a second substep comprising:
fastening at least one reference object having recognizable features to the first robot kinematic system,
fastening at least one 3D digitizer to the second robot kinematic system or to a third robot kinematic system, and/or fastening the at least one camera to the second robot kinematic system or to the third robot kinematic system,
bringing the at least one reference object and the at least one 3D digitizer and/or the at least one camera into different relative poses with respect to one another by the first robot kinematic system and at least one of the second and third robot kinematic systems, and
recording data of the recognizable features of the at least one reference object by the at least one 3D digitizer and/or the at least one camera in the different relative poses;
a second step comprising:
generating calibration data, which correlate the recorded features of the at least one reference object in a coordinate system, at least from a portion of the data recorded in the first step; and,
a third step comprising:
deriving calibration parameters for at least one robot kinematic system from the calibration data generated in the second step and at least from a portion of the data recorded in the first step;
wherein:
in the first substep, for generating the calibration data in the second step and for deriving the calibration parameters in the third step, at least a portion of the data of the recognizable features of the at least one reference object are data which is generated by the at least one camera and, for deriving the calibration parameters, at least a portion of the data of the recognizable features of the at least one reference object are data which is generated by the at least one 3D digitizer, and
in the second substep, for generating the calibration data in the second step and for deriving the calibration parameters in the third step, the data is any selection of the data which is generated by the at least one camera and/or the at least one 3D digitizer.

2. The method as claimed in claim 1, wherein the at least one 3D digitizer is a triangulation sensor.

3. The method as claimed in claim 1, further comprising at least one of:
providing a scale-defining element on the at least one reference object, and defining a robot link as the scale-defining element.

4. The method as claimed in claim 1, wherein the recognizable features of the reference object are correlated in absolute terms by at least one absolute measurement with the at least one 3D digitizer, and
wherein the at least one 3D digitizer is a scale-defining element.

5. The method as claimed in claim 1, further comprising:
transferring at least a portion of data of the recognizable features of the at least one reference object which are present in a local reference coordinate system of the at least one 3D digitizer and/or which are present in a local reference coordinate system of the at least one camera into a global reference coordinate system.

6. The method as claimed in claim 1, wherein the calibration data of the recorded features of the reference object are generated and the calibration parameters of the at least one robot kinematic system are derived, or
wherein the calibration parameters of the at least one 3D digitizer or of the at least one camera are adapted,
by minimizing the deviations between first coordinates of the recognizable features of the reference object recorded by the at least one 3D digitizer and/or the at least one camera and second coordinates of the recognizable features of the reference object calculated from a mathematical model.

7. The method as claimed in claim 6, wherein the calibration parameters of the robot kinematic system are at least one of:
geometric calibration parameters,
elastic calibration parameters,
thermal calibration parameters,
calibration parameters of the at least one robot kinematic system which take into account a configuration of the at least one robot kinematic system,
calibration parameters which take into account a direction of approach,
calibration parameters of a characteristic of error curves or calibration parameters for determining the error curves of a length or angle measurement technology of the at least one robot kinematic system,
calibration parameters which characterize a play of individual or all axes of the at least one robot kinematic system, and
calibration parameters which describe a dependence of the at least one robot kinematic system on other variables, which may be recorded with sensors or which may be calculated based on existing data.

8. The method as claimed in claim 6, further comprising at least one of:
determining the pose of at least one end effector of the at least one robot kinematic system based on the calibration parameters, and
aligning the at least one end effector of the at least one robot kinematic system based on the calibration parameters.

9. A method for calibrating a plurality of robot kinematic systems, the method comprising:
fastening, in each case, at least one of: (a) the at least one 3D digitizer, (b) the at least one camera, and (c) the at least one reference object to the plurality of robot kinematic systems, and
calibrating at least one of the at least one robot kinematic system with the method as claimed in claim 1.

10. The method as claimed in claim 9, wherein the plurality of robot kinematic systems are calibrated relative to one another.

11. The method as claimed in claim 1, wherein the at least one robot kinematic system is a rotary table.

12. The method as claimed in claim 1, further comprising:
fastening one or more further tools to the at least one robot kinematic system in addition to the at least one 3D digitizer and/or the at least one camera and/or the at least one reference object, and/or
replacing the at least one 3D digitizer and/or the at least one camera and/or the at least one reference object by the one or more tools fasted to the at least one robot kinematic system.

13. The method as claimed in claim 1, wherein the at least one reference object is configured such that the recognizable features are located on at least one of:
a separate body,
a wall provided with recognizable features,
a further robot kinematic system,
one or more arbitrary links of a robot kinematic system,
the at least one 3D digitizer,
the at least one camera,
a tool,
a measurement object, and
around the measurement object.

14. The method as claimed in claim 1, wherein the recognizable features are at least one of:
optical markers which actively light up,
optical markers which are passively illuminated,
features recognizable in two dimensions having a unique 2D geometry, and
features recognizable in three dimensions having a unique 3D geometry.

15. An apparatus for calibrating the at least one robot kinematic system, the apparatus comprising:
the at least one 3D digitizer, wherein the at least one 3D digitizer is at least one of: fastened to a first robot kinematic system of the at least one robot kinematic system, located and fixed in the surroundings of a first robot kinematic system, and fastened to a second robot kinematic system of the at least one robotic kinematic system or to a further third robot kinematic system of the at least one robotic kinematic system;
the at least one camera, wherein the at least one camera is at least one of: fastened to the first robot kinematic system or to the second robot kinematic system, fixed in the surroundings, and fastened to the second robot kinematic system or to the third robot kinematic system; and
the at least one reference object having recognizable features, wherein the at least one reference object is at least one of: located in the surroundings of the robot kinematic system or in the surroundings of the at least one robot kinematic system, stationary for the recordings, and fastened to the first robot kinematic system,
wherein, for at least one of the at least one robot kinematic systems, calibration parameters are derived with the method as claimed in claim 1.

16. The apparatus as claimed in claim 15, further comprising at least one scale-defining element.

17. A robot kinematic system of the at least one robot kinematic system, the calibration parameters of which have been derived as claimed in claim 1.

18. A non-transitory computer-readable storage medium on which a computer program is stored, wherein the computer program includes instructions which, when the computer program is executed by at least one processor, cause the at least one processor and/or further processors to carry out the method as claimed in claim 1.

19. A method for calibrating at least one robot kinematic system, at least one 3D digitizer being fastened to a first robot kinematic system of the at least one robot kinematic system and at least one camera being fastened to the first robot kinematic system or to a second robot kinematic system of the at least one robot kinematic system, or at least one reference object having recognizable features being fastened to the first robot kinematic system of the at least one robot kinematic system, and the at least one 3D digitizer being fastened to the second robot kinematic system or to a third robot kinematic system, and/or the at least one camera being fastened to the second robot kinematic system or to the third robot kinematic system, the method comprising:
a first step comprising:
a first substep comprising:
positioning at least one reference object having recognizable features in surroundings of the first robot kinematic system or in the surroundings of the first and second robot kinematic systems, the at least one reference object being stationary for the recordings,
bringing the at least one 3D digitizer and the at least one camera and the at least one reference object into different relative poses with respect to one another by the first robot kinematic system or the first and second robot kinematic systems, and
recording data of the recognizable features of the reference object by the at least one 3D digitizer and by the at least one camera in the different relative poses, or
a second substep comprising:
bringing the at least one reference object and the at least one 3D digitizer and/or the at least one camera into different relative poses with respect to one another by the first robot kinematic system and at least one of the second and third robot kinematic systems, and
recording data of the recognizable features of the at least one reference object by the at least one 3D digitizer and/or the at least one camera in the different relative poses;
a second step comprising:
generating calibration data, which correlate the recorded features of the at least one reference object in a coordinate system, at least from a portion of the data recorded in the first step; and,
a third step comprising:
deriving calibration parameters for at least one robot kinematic system from the calibration data generated in the second step and at least from a portion of the data recorded in the first step;
wherein:
in the first substep, for generating the calibration data in the second step and for deriving the calibration parameters in the third step, at least a portion of the data of the recognizable features of the at least one reference object are data which is generated by the at least one camera and, for deriving the calibration parameters, at least a portion of the data of the recognizable features of the at least one reference object are data which is generated by the at least one 3D digitizer, and
in the second substep, for generating the calibration data in the second step and for deriving the calibration parameters in the third step, the data is any selection of the data which is generated by the at least one camera and/or the at least one 3D digitizer.
